(19) United States
(12) Patent Application Publication
(10) Pub. No.: US 2014/0298364 A1
(43) Pub. Date: Oct. 2, 2014

(54) RECOMMENDATIONS FOR MEDIA CONTENT BASED ON EMOTION

(71) Applicant: RAWLLIN INTERNATIONAL INC., Tortola (VG)

(72) Inventors: Sergey Stepanov, Sankt-Petersburg (RU); Andrey N. Nikankin, Sankt-Petersburg (RU)

(21) Appl. No.: 13/851,059

(22) Filed: Mar. 26, 2013

(51) Int. Cl. H04N 21/25; H04N 21/442

(52) U.S. Cl. CPC H04N 21/25; H04N 21/44218
USPC 725/10

(57) ABSTRACT

A conversation is facilitated that ascertains the emotional state of a user in order to recommend media content such as a movie, film, video, digital book, or other media content for enjoyment. Based on the emotional stated ascertained, media content is recommended as selections, in which a user can select via a user device to receive the recommended media content. A set of measures are further generated for one or more users to rate media content based on an emotion caused by the media content. The measures include emoticons, a text message, and/or a multiple choice selection, for example, by which the user can used to communicate the emotion caused by the media content. A tagging component tags the media content with the measure at one or more segments of the content based on the measure received from users. The tagging component is configured to identify content that has been rated or has not been rated by user for emotions that could be elicited by the media content and/or are already portrayed predominately within the media content.

### TECHNICAL FIELD

The subject application relates to media content and measures related to media content.

### BACKGROUND

Similarly, ratings of various goods, services, entertainment and any media content representing these goods and services are also subject to ambiguous interpretation. In addition, a person often has to spend time interpreting the rating system just to get a general idea of the quality of the rating. For example, ratings for movies or films may be based on a one to five star rating, in which a five star rating represents a well-liked movie and a one star or no star rating represents a disliked movie. However, these ratings are only representative to a certain group of critics, a particular group's likes and dislikes, and the ratings may only be discernable to someone who is familiar with how this particular group of critics rates a movie (i.e., five stars define “best” and one star defines “worst”). Questions remain unanswered. For example, could a four star rating mean that the movie was well financed by a bank that is also rated four stars, or could the meaning be interpreted that the film was great for visual effects, great drama, great plot, etc.? All of these questions and others are inherent to the ratings, unless a person first educates herself to the nature of the rating system being used.

To an individual discerning a rating for a particular media content, with or without an image (e.g., a star or the like), more time is often spent than is needed in trying to select the right media content (e.g., movie, or other content), which may involve the person's mood, taste, desires, etc., such as with a fit wine, a good-fit movie, a good-fit song or some other similar choice. How many times does a person have to stand in front of a Redbox movie rental station watching someone try to pick out a scary movie among two different scary movies, when all that the renter knows is that one movie is considered “horror,” and the other movie is also considered “honor”? The above-described deficiencies of today's rating systems and techniques lend for the need to better serve and target potential users. The above deficiencies are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for evaluating and recommending media content are contained herein. An exemplary system comprises a memory that stores computer-executable components and a processor, communicatively coupled to the memory, which facilitates execution of the computer-executable components. The computer-executable components comprise a conversation component configured to facilitate a conversation and receive a set of inputs to evaluate an emotional state based on the set of inputs. A recommendation component is configured to generate a determination of a set of media content based on the emotional state and communicate a set of selections as recommendations associated with of the set of media content based on the determination. A media component configured to communicate the set of media content based on a selection of the set of selections being received.

In another non-limiting embodiment, an exemplary method comprises facilitating, by a system including at least one processor, a conversation to evaluate an emotional state. The method comprises receiving a set of inputs from the conversation. The emotional state is evaluated or determined based on the set of inputs. A set of media content is determined based on the emotional state. A set of recommendations associated with the set of media content are communicated.

In still another non-limiting embodiment, an exemplary computer readable storage medium comprising computer executable instructions that, in response to execution, cause a computing system including at least one processor to perform operations. The operations comprise facilitating, by a system including at least one processor, a conversation to evaluate an initial emotional state for determining media content. The media content related to the initial emotional state is identified. Recommendations are communicated for the media content related to the initial emotional state.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF DRAWINGS

Non-limiting and non-exhaustive embodiments of the subject disclosure are described with reference to the following figures, wherein like reference numerals refer to like parts throughout the various views unless otherwise specified.

FIG. 1 illustrates an example recommendation system in accordance with various aspects described herein;

FIG. 2 illustrates another example recommendation system in accordance with various aspects described herein;

FIG. 3 illustrates another example recommendation system in accordance with various aspects described herein;

FIG. 4 illustrates another example recommendation system in accordance with various aspects described herein;

FIG. 5 illustrates an example analyzing component in accordance with various aspects described herein;

FIG. 6 illustrates an example view pane in accordance with various aspects described herein;

FIG. 7 illustrates an example of a flow diagram showing an exemplary non-limiting implementation for a recommendation system for evaluating media content in accordance with various aspects described herein;

FIG. 8 illustrates another example of a flow diagram showing an exemplary non-limiting implementation for a recommendation system for evaluating media content in accordance with various aspects described herein;

FIG. 9 is a block diagram representing exemplary non-limiting networked environments in which various non-limiting embodiments described herein can be implemented; and

FIG. 10 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon such as with a module, for example. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

### Overview

In consideration of the above-described deficiencies among other things, various embodiments are provided that generate recommendations and ratings for media content, such as films, movies, other video, text, voice, broadcast, internet sites, interactive content and the like. Media content for purposes of this disclosure can also be considered a digital representation of any consumer good, such as a final product intended for consumption rather than for production. For example, media content may be a digital book or a representation of a book, such as a title name, or the book in digital form, which can be presented over a network from a server or other client device, for example. The term “media content” is intended to mean any type of media (e.g., digital video, text, voice, photo, image, symbol, etc., in real time or non-real time), good and service, in which the good or service may be inherently digital or represented digitally.

Recommendations are provided based on an emotion expressed by a user. A conversation is facilitated that prompts the user for inputs related to an emotional state that includes the user's present emotion and circumstances surrounding the emotion. A determination is made for media content (e.g., a movie, film and the like) that most closely resembles the emotional state of the user. The media content identified is communicated to the user as a selection that can be made, or to identify potential candidates for the user's viewing entertainment. The selections can be received and subsequently media content corresponding to the selection can be provided to the user or user device, such as a mobile device, personal computer having a processor and a memory, and/or other like device.

To rate media content, a set of measures is generated and used to evaluate the media content in order to provide further recommendation. The recommendation, for example, includes a rating that is interpreted by emotions conveyed by one or more users, including other users than a user receiving the recommended media content or content selections. Users are allowed to specify their emotions in response to media content, such as with emotions felt after or during the viewing of a movie. Although, some media content can be categorized as action, adventure, science fiction, horror, romance, etc., or may be critiqued as good or bad on a certain scale, this does not always adequately equate to the emotional response that can be elicited by the media content. Embodiments herein provide additional perspective according to recommendations for media content based on a user's emotional responses as well as from user's of a general population segment, for example. Emoticons are one example of how users can express emotional responses to media content. Therefore, analyzing, interpreting, and measuring user input that expresses emotions through emoticons or other means of communication can enable additional measures to be provided to the media content, while further affording additional means of expression to users and recommendations to be output from recommendation systems based on the user input.

Emoticons have historically been used in casual and humorous writing. Digital forms of emoticons can be useful in other types of communications, such as with texting. For example, the emoticons : ) or : ( are often used to represent happiness or sadness respectively, where : D may indicate gleefulness or extreme joy. The examples do not end here, but nevertheless emoticons are understood to be a pictorial representation of a facial expression expressed using punctuation marks, letters or both that are usually placed on a visual medium to express a person's mood.

### Non-Limiting Examples of Recommendations for Media Content Based on Emotion

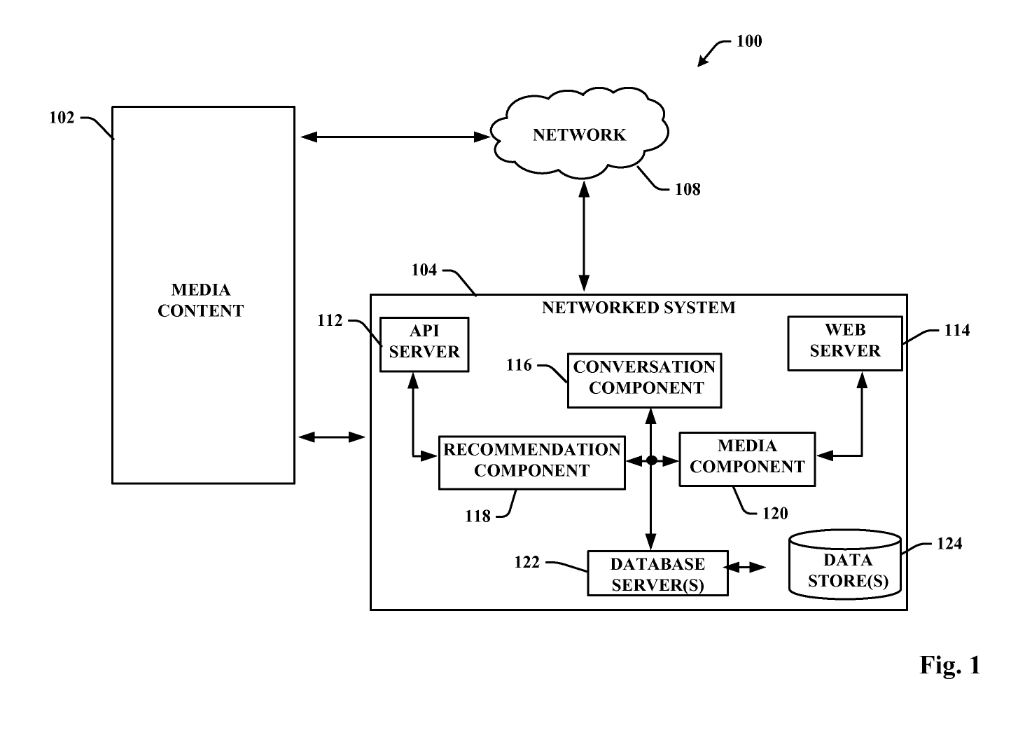

Referring initially to FIG. 1, illustrated is an example system 100 to output one or more recommendations pertaining to media content 102 in accordance with various aspects described herein. The system 100 is operable as a networked recommendation system, such as to recommend various types of media content through ratings assigned to the media content 102. For example, one or more users can provide input that is related to the media content (e.g., a movie, video, book, audio recording, and/or the other media content). The input is received by a networked system 104 configured to analyze input related to the media content 102 and evaluate the media content 102 for recommendations that involve associating the immediate subjective emotion with emotional ratings assessed to the media content.

The recommendation system 100 assessing in one example can operate to assess an emotional state of a user from inputs received and then associate the emotional state assessed to media content that is tagged with tags that rate the emotions caused by the media content. In this manner, the system 100 aids users in a decision of whether to purchase, consume and/or share the media content 102 according to their own emotional state, a different user's emotional state and/or a desired emotional state that can be elicited by the media content. The emotional state can include data related to an emotion and/or circumstances surrounding the emotion comprising time of day, a date, an event or a location of a client device from which the set of inputs are received.

The system 100 includes a networked system 104 that is communicatively coupled to one or more client devices, such as a personal computing device, a mobile device, a television viewing device and/or another viewing component via a network 108 for receiving user input and communicating the media content 102, such as a local area network (LAN), wide area network (WAN), cloud network, Internet or other type of network connection, which is referred herein as network 108. Aspects of the systems, apparatuses and/or processes explained in this disclosure can constitute machine-executable component embodied within machine(s), e.g., embodied in one or more computer readable mediums (or media) associated with one or more machines. Such component, when executed by the one or more machines, e.g., computer(s), computing device(s), electronic devices, virtual machine(s), etc. can cause the machine(s) to perform the operations described.

The network is connected to the networked system 104, which is operable as a networked system to provide recommendation output about the media content to other users or the users providing input. The networked system 104 can requests various system functions by calling application programming interfaces (APIs) residing on an API server 118 for invoking a particular set of rules (code) and specifications that various computer programs interpret to communicate with each other. The API server 118 and a web server 120 serves as an interface between different software programs, a user interface, and/or user/client devices. A database server 128 is operatively coupled to one or more data stores 130, and includes data related to various described components and systems described herein. The networked system 104 further comprises a conversation component 116, a recommendation component 118, and a media component 120.

The conversation component 116 is configured to facilitate a conversation and receive a set of inputs to evaluate an emotional state based on the set of inputs. The conversation component 116 facilitates dialogue or conversation, such as a by initiating a communication with a user device (e.g., a mobile device, a touch screen interface and the like). The inputs received can include data about the emotional state of the user, such as a current emotion, a mood, and circumstances surrounding the mood, such as data related to events surrounding the user's mood. For example, the networked system 104 via the conversation component 116 generates a set of suggestions, questions, a set of answers, a set of scenarios, a set of feedback related to the questions, answers and/or scenarios, that facilitate a conversation, otherwise known as a conversation, which is related to the emotional state of the user. The conversation can also include communicating a question comprising an open ended question and/or a set of multiple choice options related to the emotional state, as well as a choice of emoticons, such as images, for example, that represent an emotion or mood of the user (e.g., happy face, sad face, scared face, excited face, comedic face, tired face, etc.).

The conversation or communication with the client device 102 can be facilitated, for example, by providing a set of voice outputs via the conversation component 116 asking the client to review an emotion or mood and events relating to the emotion or mood of the user. The dialogue generated can be between the network system 104 and the client device 102, in which live interaction can also occur between at least one user and the conversation component 116. The conversation component 116 can facilitate dialogue through various means, such as via live interaction among two parties, a voice generated interaction, key pad interaction, chat interaction and/or interaction with various forms, questionnaires, responses, recommendations, etc.

The conversation component 116 is further configured to receive the set of inputs to further associate a measure with the set of media content, the set of measures including at least one of a set of pictorially represented emoticons, a multiple choice of emotions, and/or a text indication of the emotion for measuring the set of media content. The set of inputs received include a user interface selection, a text, a captured image, a voice command, a video, or a freeform image, that evaluates the set of media content according to the emotion caused by the set of media content.

In one example, the conversation component 116 can prompt a user for input and/or receive inputs related to a set of emoticon for ascertaining an emotion of a user. Multiple options can be obtained, for example, a scared face and a happy face could be received as emoticon images that determine that the user is in an emotional state for a scary movie that is also a happy movie or media content. In addition, other circumstances such as a rating, an audience category (e.g., children, teenagers, family, alone, with a date or spouse, etc.) can be received as input. In other example, data that a person lost their job, has had a hectic day, at a social gather, a work environment, located at a birthday party, has a birthday or other important data and/or a location can be received as data towards an emotional state of being for the user, and used by the conversation component 116 to analyze and communication for recommendations of media content.

The conversation component 116 can operate to receive emoticons from a user via a text based interface, a text message (e.g., a short messaging service, or multimedia service). The images can be analyzed to determine an emotion communicated with the emoticons and communicate the emotion to the recommendation component 118. The emoticon or message having the emoticon can include further data to the user's emotional state that includes classification data and data related to circumstances of the user, such as a location, a time, date, audience category, rating, and other information pertaining to the user's circumstances. The classification data can include a genre, a demographic, a language, and/or other classification criteria by which the system can identify recommended content to closer match the user's desires for media content. Other classifications can include the type of media content, such as a digital book, a speech, a song, an album, a video, film, and/or digital publication, for example.

The rating component 122, for example, is configured to detect an emotion from the inputs provided by various users critiquing the media content 102 and rate the media content according to one or more measures generated by a measuring or measure component 124. The rating component 122 is operable to provide output as a recommendation for the media content 102. The recommendation, for example, may be in the form of an emoticon generated from the input received, or in multiple emoticons that also have various indicators as to the weight of the emotion that conveyed by each emoticon. For example, where multiple users convey inputs that indicates a sad emotion, a sad emoticon may have an weight indication bar that is nearly completely colored, and where only a few users convey a happy emotion, only a slightly colored bar may reside near a happy emoticon. These examples are not limiting and various emoticons, emotions, inputs, and indicators as appreciated by one of ordinary skill in the art can also be used. For example, bars, graphs, charts, lines, percentages, polling statistics, sampling errors, probabilities, and the like could also be used as indicators to various other emoticons other than just a sad emoticon or a happy emoticon.

The recommendation component 118 is configured to generate a determination of a set of media content based on the emotional state of the user that is determined. The determination of the emotional state can be from the conversational component 116 in communication with the recommendation component, facilitates the conversation with the user for determining data related to an emotional state. The recommendation component 118 further communicates a set of selections as recommendations associated with of the set of media content based on the determination made of the emotional state. The selections can be in the form of digital representation(s) of the media content identified to correspond to the emotional state and/or most likely to identify with the emotional state based on a set of criteria or satisfying a predetermined threshold for a set of criteria, such a rating of emotional response from the user of similar content, and/or from other users to the media content, the classification criteria of the media content (e.g., genere, audience, a standard rating—G, PG, PG-13, R, etc., a language spoken—English, Spanish, Russian, etc., a demographic, an actor specification, a time frame or period of date produced, etc.), and/or other criteria such as a weighting to tags of the media content searched.

In one embodiment, the recommendation component 118 is further configured to determine the set of media content based on the emotional state determined and a tag that identified emotional ratings of the set of media content. For example, media content can be classified and associated with tag for a complete video, book, film, speech, etc. and/or associated with segments of each of these media content that identifies the segments with a rating and/or an emotional response that the segments could elicit from a viewer/listener of the content.

For example, one or more users could rate media content based on the emotions elicited and reported via an emoticon, text, selection and/or the like to rate the content based on a set of emotions (e.g., happy, sad, angry, envy, lusty, peaceful, etc.). The media content could then be tagged based on these ratings. In turn, if a user informs the system 100 that sadness overcomes their day, due to a death, the system 100 could operate via the recommendation component 118 to generate media content that corresponds to the media content input as a desired emotional state. In this case, the user could have indicated the emotional state comprising the emotion and circumstances surrounding the emotion, but expressed a desire to be uplifted in a comedy that focuses on being funny and not dealing with family, such as 48 hours, or Beverly Hills Copy, an older comedy with Eddie Murphy, but which may not be known or thought of by the user. The recommendation component 118 is further configured to generate the determination based on one or more tags of the set of media content, measures received for rating the media content, and the emotional state of the user determined.

The media component 120 is configured to communicate the set of media content based on a selection being received. In one embodiment, the recommendation system 100 can operate to provide media content that is selected based on the recommendations provided as selections. The media content can be downloaded, streamed, purchased, rented, and/or sampled from the media content component 120 with one or more segments corresponding to the emotional state of the user and corresponding to the recommendations generated as a result of other user emotional ratings and/or the ratings of the current user device in which the conversation is facilitated with for determining the emotional state.

In another embodiment, the system 100 can operate to continuously learn characteristics and behavior of a user by generating user profile data over time. The system 100 can thus operate at an initial interaction with a user without having user profile data by assessing an emotional state and/or receiving media content measures that are based on an emotion elicited from various the media content, but can also operate dynamically by tracking characteristics and activities of the user for determining various habits related to media content.

For example, a user could at different points of a week and/or different dates of a year favor various types of content, such as romantic science fiction novels during winter, and comedies on Friday nights. The user profile data can include behavioral patterns, such as purchases, viewing information, repetitive viewing of types of media content, content shared online, content that is searched through key word identification at a search engine, and other activities related to media content through a user device and/or the networked system 104.

The conversation component 116 discussed above can operate on a continuous basis with updated user profile data in order to facilitate the conversation towards receiving inputs of an emotional stated. Thus recommendations can be provided to a user with more accurate information over time by continuing to collect and update user profile data related to a user and/or the user's household members or visiting guests, in case in which guests and/or members frequently or regularly engage with media content.

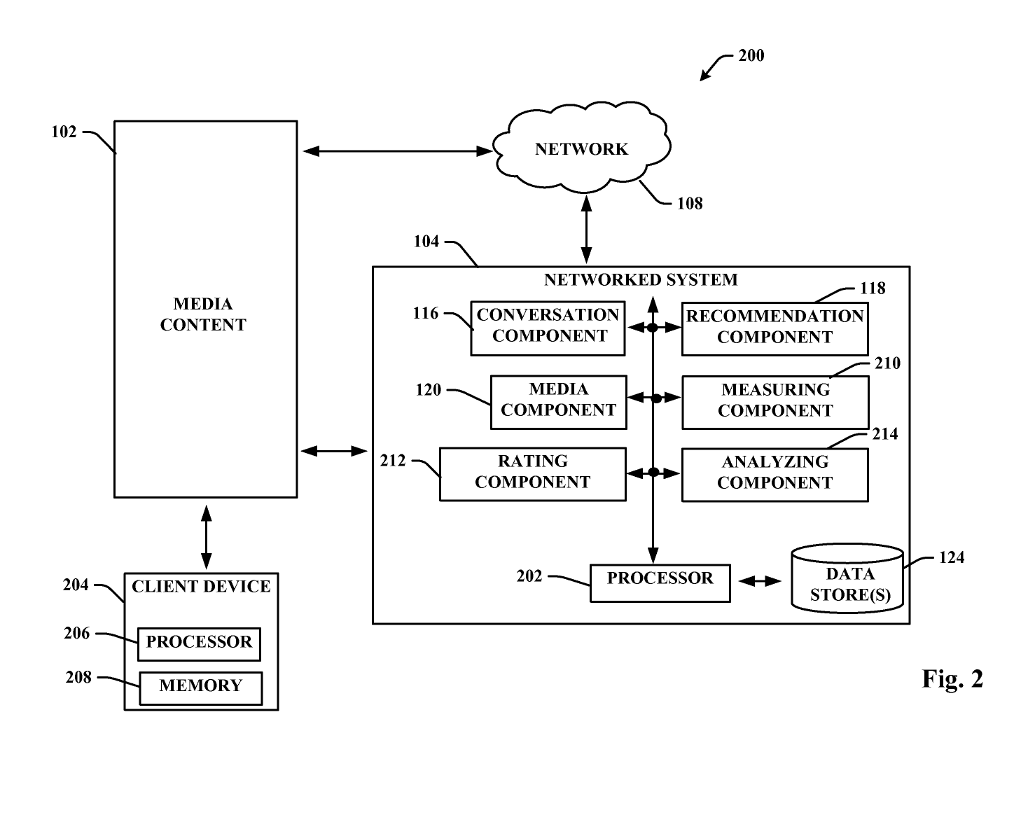

Referring to FIG. 2, illustrated is an exemplary recommendation and rating system 200 in accordance with various aspects herein. The system 200 includes the networked system 104 comprising a processor 202 communicatively coupled to the data store 124. The networked system 104 is further communicatively coupled to a client device 204 that comprises a processor 206 and a memory 208. The client device 204 can include a display device that renders media content in a display such as a mobile device, a mobile smart phone, a personal computing device and/or a computing device. The networked system 104 further comprises a measuring component 210, a rating component 212, and an analyzing component 214.

The measuring component 210 is configured to generate a set of measures corresponding to media content for one or more users. The set of measures may be indicative of the type of media content, and can be predetermined or dynamically configured by a logic of the measuring component 210 based on the type of media content, such as video content and/or audio content. For example, the measures can be generated by the measuring component 210 as emotions that can be selected from a choice of emoticon images, text, images, etc. The measures can further be discernible from one or more user inputs received, in which a user is asked or questioned to rate media content based on a measure of the user's emotion. The user can input, communicate and/or selection an emotional image, such as an emoticon. For example, the user can be asked to review media content according to the emotions that the media content elicited at the time of purchase for previous media content received, or some other time for media content already reviewed. In one example, the user can be provided an incentive for answering whether or not media content has been viewed and further providing an indication (e.g., a text message having a emoticon, a voice input indicating one or more emotion(s) and/or a selection of emoticon(s)).

The measuring component 210 operates in communication with the other components discussed above, and thus, operates for ascertaining media content that relates to the desired emotional state or emotional response that the user has communicated via the conversation component 116. For example, where the media content 102 is a movie that predictably invokes sadness in the audience of users viewing the movie based on measures received from other users, a sad face can be received or interpreted from input from the client device 204. The measuring component 210 can dynamically generate a sad image as one measure for the set of measures associated with the movie to be selected from, and/or operate to also receive a sad face (e.g., an emoticon, text based image, and/or other image) from the client device 204 as an email, text based message, or the like, and discern from the image that an emotion of sadness is associated with the particular media content. As such, a dynamic generation of selections of emotional images can be provided to a user to select from, and the measuring component 210 can operate to discern that a text based image is a particular emoticon that is associated with a particular emotion.

For example, a sad image can be a sad face, a crying face, etc. that is predetermined and set as a measure by the measuring component 210 corresponding to the movie as the media content 102. The sad face can be generated dynamically by the measuring component 210 via an analysis of the media content, such as a colon and an open parenthesis—: (, and if selected or received from as a measure can operate to establish that sadness predominates within the movie or as an emotion that the movie elicits. In addition, for example, the measuring component 210 is operable to interpret input received from the one or more users and appropriately assign a sad face as one measure of the set of measures generated for the movie, which may be based on a predetermined number of inputs (e.g., more than two or three) analyzed as indicating sadness, in order to safeguard against false positives for a sad emotion as being received by a user.

The measure component 124 can operate to generate measures, for example, such as images or emoticons indicating sadness, happiness, excitement, surprise, angry, hurt, sleepy, scared, etc. Various types of emotions can be interpreted and utilized from the measuring component 210. For example, sad, angry, happy, romantic, greed, lust, hunger, sick, fear, tired, annoyed, drunkenness, dizziness, inquisitive, relieved, confused and the like may all be expressed by users as well as be images or emoticons that are dynamically generated by the measuring component 210. The media content, as discussed above, may be a movie, but also the media content may be anything that invokes an emotion, which may be represented by media content, such as with a consumable good and/or a service, which may include various forms of movies or entertainment.

The rating component 212 is configured to detect the emotional state from the set of inputs and rate the set of media content according to a measure selected from the set of measures in response to the emotional state detected. For example, the rating component 212 associates the measure selected or received with the media content 102. For example, if sadness is determined from the user inputs, then a sad image from the set of measures is associated with the media content. Multiple associations can be made by the selection component regarding one or more media contents with multiple different emotions and/or from multiple different users that provide a weighted measure rating the media content based on a percentage, an average, and/or number of individual emotional votes to the media content. For example, some inputs received could be associated with a sad emotion, while others received with an angry emotion, and, in turn, these inputs can be associated with a sad image and a mad image respectively among the set of measures the media content. Thus, users deciding which media content to select can have further indication and/or recommendation variables upon which to receive media content.

In one example, the rating component 212 associates a rating as a scale or range to each of the media content (e.g., a movie, digital book, and the like). The rating can comprise an average of various inputs and indicate that one or more emotions thought to be elicited by the media content or movie, for example, have been determined based on the user's that have provided input. A five star system to each emotion associated with the media content can be generated. Alternatively or additionally other rating systems can be envisioned, such as a color scale from red to black can be associated to each emotion, a percentage, an average of votes on a one to ten scale, and/or some other rating can be provided with an indicated emotion (e.g., an emotional image) to the media content.

The analyzing component 214 can operate to analyze inputs that are received at the conversation component 116 and determine one or more emotion(s) being expressed for an emotional state or as a measure to rate media content based on an emotion. The inputs can be received from an electronic device or from the client device 204, such as from a client machine, a third party server, or some other device that enables inputs to be provided from a user. The client device 204 can be a cell phone, for example, and the inputs received can be from a touch panel that permits a user to input information thereto, such as microphone, keypad, control buttons, a keyboard, a gesture-based device, an optical character recognition (OCR) based device, a joystick, a virtual keyboard, a speech-to-text engine, a mouse, a pen, voice recognition and/or biometric mechanisms, and the like. The analyzing component 214 can receive various inputs and analyzes the inputs for indicators of various emotions being expressed with regard to content media. For example, a text message may include various marks, letters, and numbers intended to express an emotion, which may or may not be discernible without analyzing a store of other texts, or ways of expressing emotions. Further, the way emotions are expressed in text can changed based on cultural language, different punctuations used within different alphabets, for example. The analyzing component 214 is thus operable to discern the different marks, letters, numbers, and punctuation to determine an expressed emotion from the input, such as a text or other input from one or more users in relation to media content.

In one example, a user is able to receive recommendations from the system 200 based on an emotional state determined, on emotionally rated media content, and/or further rate media content according to emotion and emotional images such as emoticons. For example, a user can be having a bad day and desire to have a movie that is fun for the user and related family members, as well as suspenseful. Thus, the user could select and/or provide selected text for an emoticon such as : p and : o to indicate funny, silly and suspenseful. Other images could be delineated as well and correspond to different emotions. For example, the analysis component 214 could alter a text message to an emotional image by changing a colon and a closed parenthesis, for example, into a happy face, or some other combination of text and transformation into a different graphic expressing an emotion. As such, the system 200 can recommend content in a particular order that has been rated, or that has been tagged separate from other ratings based on a tagging algorithm for segmenting media content into one or more sections expressing various emotions, such as laughter, crying, joy, anger, etc.

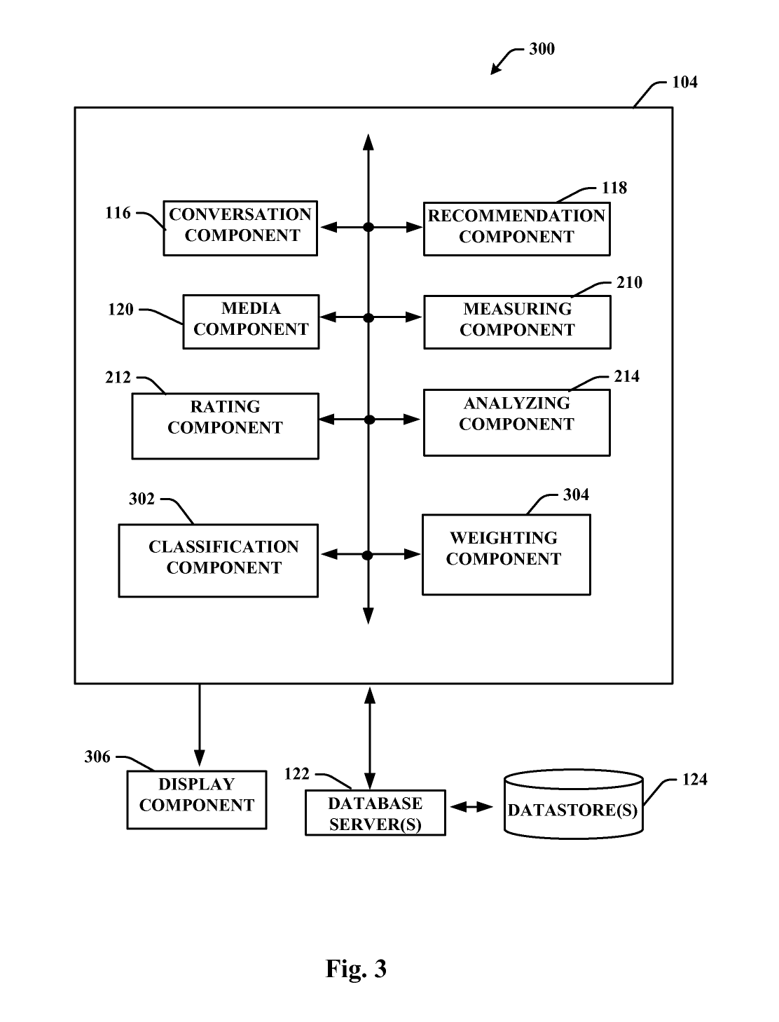

FIG. 3 illustrates exemplary embodiments of a recommendation system 300 that provides recommendations and rates media content, such as movies, films, etc., in accordance with various aspects described herein. The recommendation system 300 generates assessments based on tags to media content that indicate one or more emotional responses that are potentially elicited from the media content. Future users are then able to easily critique and express themselves about media content, receive more accurate recommendations, as well as assess various choices based on the emotional responses of other users when making decisions.

The recommendation system 300 includes a computing device or networked system 104 that includes components similar to the components discussed above. Based on the emotion ratings generated by the rating component 212 (e.g., one or more emoticons indicating an emotion), the recommendation system 300 is configured to dynamically generate an overall assessment or evaluation of media content to users and communicate recommendations based on an emotional state of the user as assessed by the system 300. The networked system 104 includes a classification component 302 and a weighting component 304.

The classification component 302 is configured to classify the set of media content in a classification based on the set of measures and/or some other classification criteria. The classification can be an emotion, as well as a genre, actor/actress, time period, a language, a publisher, a demographic or regional boundary, an audience appropriateness such as by a standard rating (e.g., G, PG, PG-13, etc.). The classification component 302 can operate to classify the media content (e.g., videos/films, etc.) base on multiple emotions so that different categories have different emotions associated with the media content and each category can have sub0-classifications based on a different emotion.

The classification component 302 can also categorize one or more measures that are selected based on the inputs received into audience categories. For example, an input that is received by a cell phone text providing a “surprised” emotion (e.g.,: O) can be classified according to the user who is communicating the feeling of surprise in relation to a media content (e.g., a movie, television episode, or the like). For example, if the user is a teenager, a media content that is rated with a surprise emoticon (e.g., an image of a person transformed into surprise from the text) would be classified as a teen emotion. In other words, the user or the audience of the content media is used to classify the emoticon rating according to knowledge already known about the user or from knowledge provided by the user, such as with metadata or additional data attributed to the user from a user profile or the like.

The classification component 302 generates audience categories that can include classifications according to age, gender, religion, race, culture or any number of classifications, such as demographic classifications in which an input that expresses a user's emotion is categorized. In another example, a user could provide an input, such as via text or a captured image from a smart phone of a teary face. If the user has a stored profile, the input could be processed, analyzed and used to provide a measure (e.g., an emoticon image of a sad face) in associated with the book so that other potential readers would understand that at least one user was very sad after reading the book. In addition to having a sad emoticon, an icon designating one or more categories for the user is also generated. The category can be an icon, such as an X for generation X or a Y for generation Y. Further, other icons indicating the age range, interest or audience category (e.g., skater, sports jock, prep, profession, etc.) can accompany the rating. In this fashion, the system 300, for example, receives a number of sad inputs from various different user's, each sad emotion that is interpreted from the inputs can be counted by a counter and then the sad emoticon generated can be weighted accordingly with one or more audience classification icons that further identify the group of user's providing the inputs.

The recommendation component 302 further includes a weighting component 304 that is communicatively connected to the classification component 306. The weighting component 304 is operable to generate a set of weight indicators that indicate weighted strengths for the set of measures generated by the measuring component 212. For example, weight indicators can include, but are not limited to, bars, graphs, charts, lines, percentages, polling statistics, sampling errors, probabilities, and the like. For example, where the set of measures include various emoticons, the weight indicators generated from the weighting component provide a weight indication as to the strength of the measure. In one example, a happy emoticon is a measure that could be determined as a corresponding measure to the input for emotion received from a user rating a movie. However, while one particular movie elicited a happy emotion as expressed by the user, the same movie could elicit an angry emotion expressed by another user who has viewed the movie. Further, multiple users could provide inputs corresponding to happy and/or angry. Therefore, recommending the movie based on user inputs would not be entirely accurate if the recommendation only included happy emoticons or angry emoticons as measures.

In one embodiment, the weighting component 304 is configured to generate weighting indicators as icons associated with a measure of a set of measures. For example, where multiple users convey inputs that indicates a sad emotion, a sad emoticon may have a weight indication bar that is nearly completely colored based on a percentage of users providing their emotional input regarding media content via voice, text, image, graphic, photo, etc. For example, where only a few users convey a happy emotion, only a slightly colored bar may reside near a happy emoticon. In one example, the weighting indicator represents a poll of users and operates as a voting function, so that some measures (e.g., a happy emotion and a sad emotion) are provided percentages or levels. Additionally, the weighting indicators can be configured to provide a level of intensity that an emotional response is generated from media content, in which may be expressed through different colors can be assigned to each measure selected. These examples are not limiting and various emoticons, emotions, inputs, and indicators as appreciated by one of ordinary skill in the art can also be used.

In other embodiments, the system 300 provides the media content, such as via a website, a network, and/or other communication link. Users can select the measure (e.g., caption, image or emoticon) or indicate directly their emotion as the best indicator of their emotion. Alternatively, users can select multiple emotions and rate them in an order of priority so that weight indicators from the weighting component 304 are also weighted based on a statistical curve that indicates priority strength of the weight indicator. For example, a bell curve, Gaussian curve, etc., could be utilized with a priority rating for each measure and a corresponding weight indicator, such as a percentage or the like, as discussed above.

The computing device 104 is configured to recommend and also provide media content as segments, video content, audio content, digital text content, etc. to a user based on an emotional state communicated by the user and determined by the system. For example, the media content can be a movie or film that is streamed online to the user for viewing from a website. In other example, the movie could be provided to the user over a television network through a television. As discussed above, any number of electronic devices could be used by the user to view the media content, and in which the system 300 is in communication with to transmit the media content.

The networked system 104 can include a display component 306 that is configured to generate a user interface and a viewing screen for users critiquing, providing input, logging on to an account, creating a profile, viewing other responses to make a media content selection, which are based on the emotional responses to the media content. The display component can generate a display, such as in a view pane or window for users to interface with various selections of media content provided as recommendations by the recommendation component 118 and to display the media content. For example, the display component 306 can operate to display at least one measure of the set of measures with a weight indicator, an audience category, and other elements such as a priority indicator, for example. A user can then observe the selections and/or recommendations and provide input to receive, rent, purchase and/or view a segment of the media content.

The display component 306, for example, can operate as a touch screen interface by which inputs for the conversation being facilitated to ascertain a user's emotional state. The system 300 can also receive one or more emotions that rate media content that has been viewed and/or display ratings from other users as described in the embodiments above.

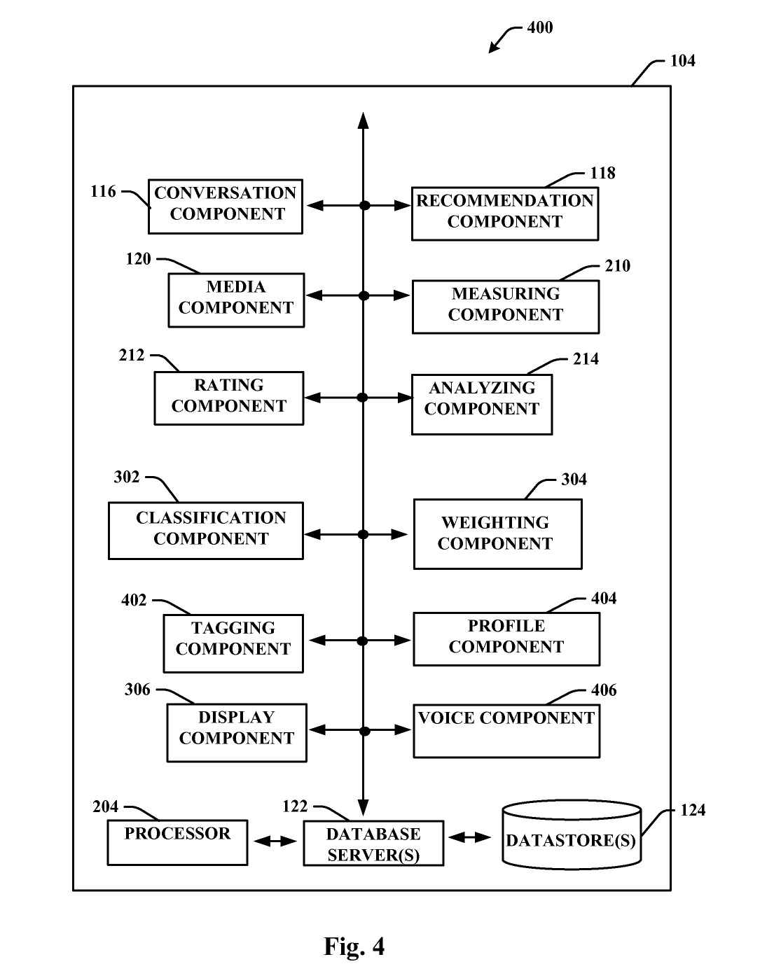

Referring to FIG. 4, illustrated is the system 400 having similar components as discussed above for communicating recommendations of media content based on an emotional ascertained from a user. The computing device 104 further comprises a tagging component 402, a profile component 404 and a voice component 406 that further operate to identify media content associated with various emotions and recommend content based on the inputs received for determining the emotional state.

The tagging component 402 is configured to analyze the set of media content and associate a tag to the media content and/or to one or more segments of the set of media content based on the rating determined by the rating component. The tag can include, for example, a keyword, term and/or an associated piece of information (e.g., a bookmark, digital image, and/or file content, that aids in determining emotions that have been elicited by the media content from one or more user's and/or from analysis of the media content identifying events and emotions surrounding the events as expressed by the media content. For example, a video content could express comedy by people laughing at a segment of the video. This portion of media content thus can be identified as humorous and/or happy, for example. Other portions or segments can also be tagged with data from user feedback (e.g., one or more emotions expressed) that corresponds to particular segments, and/or emotional ratings (e.g., emotions expressed) such as through emoticons corresponding to the entire content.

The tagging component 402 therefore operates to average and/or generate a statistical comparison of the tags associated within one media content (e.g., a movie) with tags of another media content (e.g., a different movie) in order to generate a comparison of media content. The comparison can be among tags for content that is of the same classification, and/or same type of media content (e.g., video, audio, digital book, etc.). Additional or alternatively, the comparison provided with the tags can be from among content in general, in which the user can be desiring recommendations for a particular emotion associated with the content, such as a sense of wonder and a happy ending. For example, if the user desires a comedy that is romantic, various tags could be identified with kissing scenes and laughing scenes among the media content and also factoring the emotions that other users have provided to rate the media content as romantic and comedic, such as through emoticons texted, selected, and/or received by the system 400.

The recommendation component 118 is further configured to determine the set of media content based on the emotional state that is ascertained through the conversation with the user and the tag to the set of segments of the set of media content. The tags associated to the media content via the tagging component 402 can be compared to determine which media content most closely matches the user's emotional state as identified by the system 400. The tagging component 402 can enable the recommendations component 118 to find media content of different emotions that are identified via the tags at various segments of the media content and the ratings that can also be tagged to the media content. The recommendation component 118 can thus generate recommendations with user rated indications of emotions that have been elicited by the content in other users and according to the emotional state of the user.

In one embodiment, the segments that are determined to be similar to the desired emotional state of the user can be previewed so that the user is not receiving just the most relevant media content, but a range of media content based on a predetermined threshold number. A user can sample each segment for determining emotions by viewing that segment. Additionally or alternatively, a user can further sample segments that are most rated for a particular emotion or emotions, and also identified as having a particular emotion associated with it based on emotions recognized by the tagging component 402. Therefore, the rating component 212 can operate to not only associate measures of emotion to whole pieces of media content, but to subsets or segments within. The tagging component 402 can communicate with the rating component 212 and associated tags with the ratings from users that measured an emotion to a segment, also with an indication that a segment or portion of the video content marked is also identified based on laughter, and/or other emotions that are identified or recognized within the content by the system 400.

For example, the system 400 could rate media content with a greater strength (e.g., on a rating scale of one to, a letter grade from A to F, a five star scale, etc.) for comedy if laughter is identified within a predetermined number of segments and also when a number of users have associated or measured the content with a smile face emotion rating or some other emotion involving laughter. The combination can be averaged, or the ratings can be separate in which users could provide an average rating of a B to media content, and a separate rating provides a number of segments that are tagged with laughter, for example. The user ratings and tags indicating emotion can be separate, or combined with the ratings from user's also being tagged to one or more segments of the media content.

The profile component 404 is configured to generate user profile data with respect to time from the emotional state and the measure received of the set of measures. The user profile data can includes one or more preferences for content, such as user likes and dislikes based on genre, standard rating—G, PG, etc., location, actor, actress, writer, etc. and also include behavioral patterns of the user, such as purchases, past viewed content, past ratings of media content, dates, times, etc. that provide information about the user's general preferences and behavioral habits over time. The recommendation component 118 is thus better able to provide recommendations based on the particular user as well as on the emotional state of the user as provided or determined based on conversation/inputs of the user to the system.

For example, a user could typically enjoy comedies and romances, therefore, even though the user is in a different emotional state, the recommendation component 118 could still factor in the general preferences of the user to provide media content recommendations comprising a comedy, a romance, and/or a romantic comedy. Other combinations of emotions and media content can also be envisioned as discussed herein.

The inputs received and/or communicated can be from a voice component 406, which can operate as a voice receiving device and generate a voice as part of the conversation facilitated with a user. The voice can question a user with an open ended question, a closed ended question, a statement, etc. in order to prompt the user for inputs related to an emotional state, an emotional measure related to media content, and/or other information pertaining to a user's circumstances surrounding the emotional state of the user. The recommendation component 118 is further configured to generate the determination based on the tag of the set of media content, the measure received, and the emotional state determined.

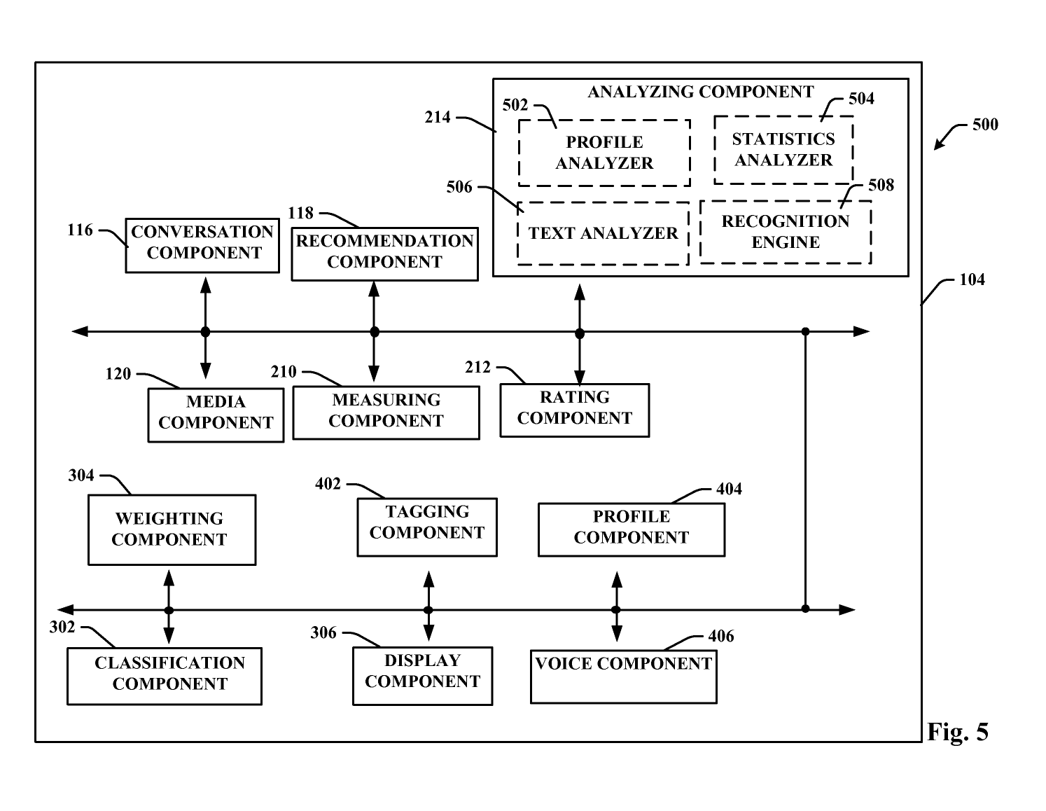

Referring now to FIG. 5, illustrated is a system 500 that analyzes a profile of a user in order to further provide recommendations for media content, determines a user's emotional state and communicate media content recommendations according to the user profile data and the emotional state. The system 500 includes components as discussed above including the analyzing component 214. The analyzing component 214 further includes a profile analyzer 502, a statistics analyzer 504, a text analyzer 506 and a recognition engine 508 that are configured to analyze inputs received to determine an emotion from one or more users.

The profile analyzer 502 can prompt a user to provide at least one input based on emotions elicited by the media content and/or from a current emotional state comprising an emotion and surrounding circumstances of the emotion. The profile analyzer 502 is further configured to receive information associated with one or more users in order to generate and store user profile data. Information about the user providing emotional input about the media content is stored and categorized in order to provide audience categories according to demographic information, such as generation (e.g., gen X, baby boomers, etc.), race, ethnicity, interests, age, educational level, and the like. User profiles can be used by the profile analyzer 502 to compare various user profiles generating emotional responses to particular media content in order to provide emotional ratings according to different categories. For example, for users of one demographic the rating could be of one emotion and other demographics could rate the media content according to a different rating.

The profile analyzer 502 further operates to store the emotional state determines from the user inputs as an initial emotional state and then compare the rating, which includes the emotional response as measures as a subsequent emotion elicited by the media content. Thus, the recommendation component 118 learns a user over time and bases greater strengths with one classification of content (e.g., a particular genre, audience category, actor/actress, language, producer, location, etc.) over another based on past selections of the user and past discrepancies between an initial emotional state and a subsequent emotional state following the media content.

The statistics analyzer 504 is configured to generate statistics related to the various user profiles and user profile data corresponding to different inputs being received by the analyzing component 214 associated with media content. For example, different graphs or charts can be generated by the profile analyzer to display demographics of emotional inputs about a movie. These graphs can be compared by the statistics analyzer 504 to generate percentages, or weights for different categories of audiences (e.g., one or more users viewing the movie) according to the measures (e.g., emoticons, images or the like) generate for the media content (e.g., a movie, etc.). For example, a percentage of Asians may show great joy towards a violent film, as opposed to a different ethnicity, nationality, age group, etc. may show disgust or honor due to the films gruesome character. However, some users from different groups could overlap to show similar emotions in the input responses, especially, for example, where the movie was good in some aspects and certain emotions could become overlooked although still inputted as multiple different emotions. In addition, some user may favor a certain emotion over other users who may not. Honor could bring some happiness, while others sadness or disgust. Further, some age groups may favor one type of emotional response over other age groups, in which some responses may be similar among the age groups even though the majority of inputs provided from each of the age groups are different (e.g., happy in a first age group, and sad in another second age group).

The text analyzer 506 is configured to analyze text inputs that are received from users in order to decipher certain features from the text relating to the user's profiles or to decipher certain emoticons in text so that the emoticons converted to a different second emoticon that is an image or an emoticon better expressing visual emotion relating to the media content. A recognition engine 508 is configured to recognize facial features and voice recognition elements from the inputs received from various users. For example, a user can capture an image of themselves or of a group of users after viewing a movie in order to provide the emotional inputs to the system.

The recognition engine 508 is configured to automatically identify or verify a person (e.g., user) and their facial expressions from a digital image or a video frame from a video source in order to ascertain an emotion. In one embodiment, the recognition engine 508 does this by comparing selected facial features from the image and a facial database with a recognition algorithm, such as with the data stores 130, discussed above. The recognition algorithms, for example, can be divided into two main approaches, geometric, which examine distinguishing features, or photometric, which is a statistical approach that distills an image into values and comparing the values with templates to eliminate variances. The recognition algorithms include Principal Component Analysis using Eigen values, Linear Discriminate Analysis, Elastic Bunch Graph Matching using the Fisherface algorithm, the Hidden Markov model, and the neuronal motivated dynamic link matching algorithm.

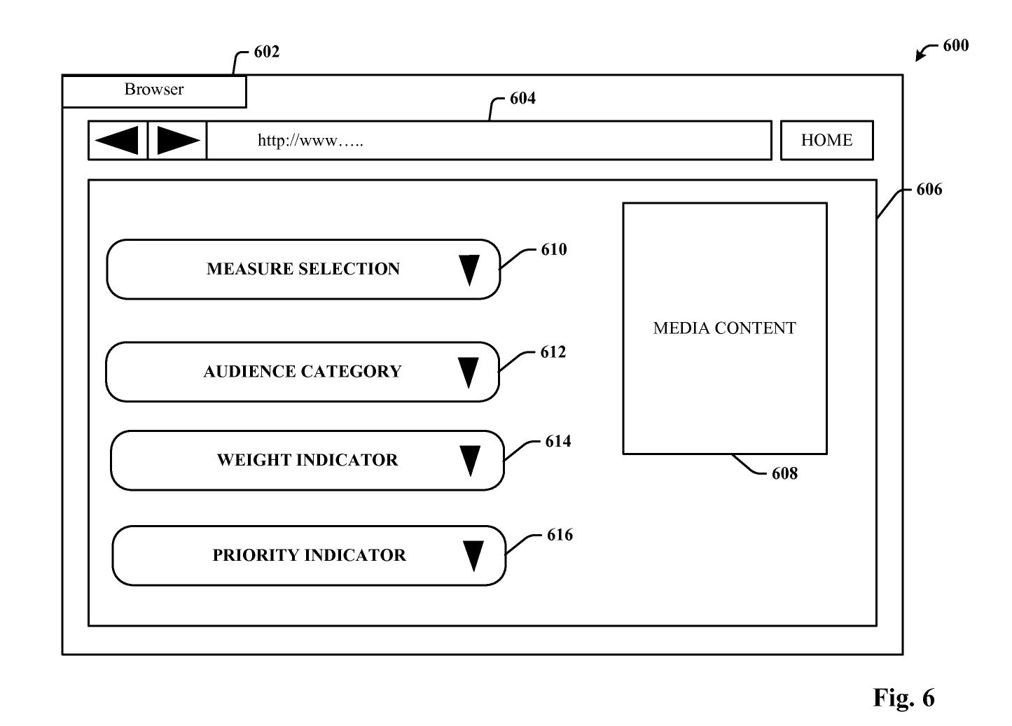

Referring now to FIG. 6, illustrated is an example input viewing pane 600 in accordance with various aspects described herein. The display component 306 can generate a display of a viewing pane. In embodiment, a user can enter selections via a user interface, such as through a shopping portal or other portal on an online site for purchases items or local services, such as expressed by media content. The viewing pane 600 can be associated via a web browser 602 that includes an address bar 604 (e.g., URL bar, location bar, etc.). The web browser 602 can expose an evaluation screen 606 that includes media content 608 for viewing either directly over a network connection, or some other connection, or for evaluation as media content that is representative of the good, service or entertainment that is being evaluated by a user.

The screen 606 further includes various graphical user inputs for evaluating the media content 608 by manual or direct selection online. The screen 606 comprises a measure selection control 610 (e.g., selections of various emotions), an audience category control 612 (e.g., a classification of types of media content), a weight indicator control 614 (e.g., for providing different weights to ratings), and a priority indicator control 616. Although the controls generated in the screen 606 are depicted as drop down menus, as indicated by the arrows, other graphical user interface controls. For example, buttons, slot wheels, check boxes, icons or any other image enabling a user to input a selection at the screen. Theses controls enable a user to log on or enter a website via the address 604 and provide input having their emotional responses via a selection.

In one embodiment, users can select multiple emotions and rate them in an order of priority so that weight indicators from the weight indicator control 614 are also weighed on based on a statistical curve that indicates priority strength of the weight indicator. For example, a bell curve, Gaussian curve, etc., could be utilized with a priority rating for each measure and a corresponding weight indicator, such as a percentage or the like, as discussed above.

In another embodiment, the priority indicator control 616 provides different priority indicators that can be generated, selected as a setting, and/or predetermined. For example, where inputs are received about a movie from the group of users discussed above, a movie could also elicit multiple responses from a user. For example, a user watching the movie could have a complexity of emotions ranging from sad, delightful, peaceful, angry and thoughtful all at once.

Therefore, different priorities could also be ascertained from captured images, text, voice, user selections, etc. that indicate an emotion either for an initial emotional state or a subsequent emotion that measures the media content. In addition, each input analyzed could be weighted with an average weight, a median weight or some other statistical measure that is calculated with the statistics analyzer 504 of the analyzer component 214, for example. For example, a user may give certain priorities to different inputs or selections corresponding to the media content. Therefore, users expressing happiness as a certain percentage could also have a weight given to this input based on if this is the primary emotion expressed among multiple emotions expressed by one user. Therefore, a potential user evaluating the media content would view a happy emoticon having fifty percent that is weighted with a primary, secondary or tertiary rating, which is more heavily expressed from those users already having evaluated this media content with their emotions. Alternatively, a scoring could be expressed and used in the weighing of the emoticon and weight indicators, such as a five, for example. Therefore, fifty percent of users feel happy by the media content, as and a five (e.g., on a scale of 1 to 10) could indicate that half of the fifty percent of users provided this as their most dominant emotion felt, but other emotions were also elicited, for example. Therefore, the priority indicator gives a strength indication to the accuracy of the measure selections and weight indicators to gauge the emotion elicited by the media content.

While the methods described within this disclosure are illustrated in and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases. Reference may be made to the figures described above for ease of description. However, the methods are not limited to any particular embodiment or example provided within this disclosure and can be applied to any of the systems disclosed herein.

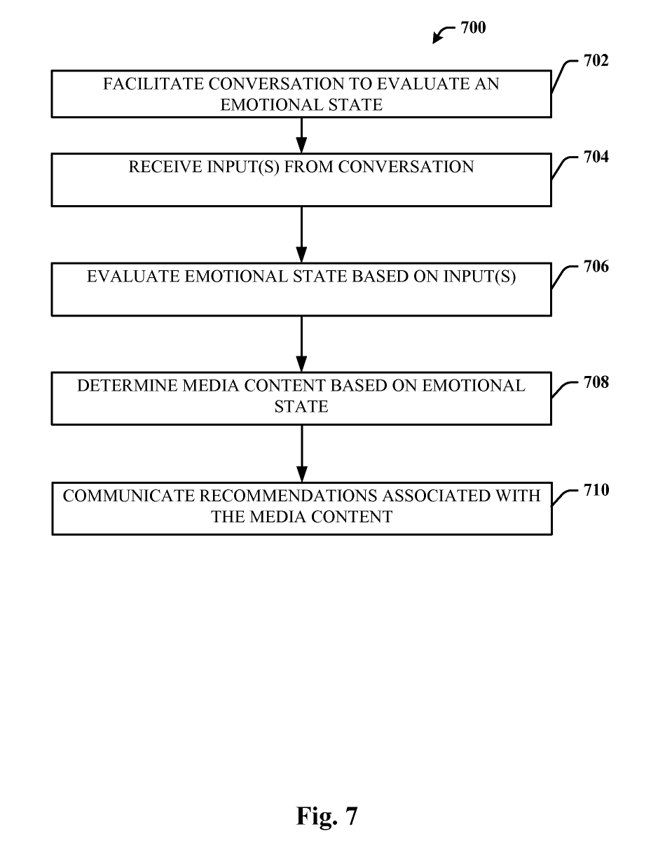

An example methodology 700 for implementing a method for a recommendation system is illustrated in FIG. 7. Reference is made to the figures described above for ease of description. However, the method 900 is not limited to any particular embodiment or example provided within this disclosure.

FIG. 7 illustrates the exemplary method 700 for a system in accordance with aspects described herein. The method 700, for example, provides for a system to interpret inputs received expressing emotions of one or more users from media content. An output or recommendation can be provided based on analysis of the received inputs with emotions. In addition, users are provided an additional perspective for evaluating goods and services, such as entertainment, and determining whether to purchase, view, share, or otherwise participate in various media content and can rate the media content in return.

At 702, the method beings with facilitating, by a system including at least one processor, a conversation to evaluate an emotional state. For example, as discussed above a conversation component can initiate a question, a statement and/or other communication to a user device to receive one or more inputs for determine what the emotional state of the user is. For example, the system could be initiate in response to a user action, a user input and/or other stimulus, such as from a user making a media content purchase, searching a media content, viewing a subscription video site and the like. The conversation can be a dialogue to prompt a user to respond as to what their current emotion is, a desired emotion to be elicited via media content, and/or fact surrounding their emotion (e.g., a death, job loss, birthday, holiday, vacation, relationship break-up, child misbehaving, etc.).

At 704, a set of inputs can be received from the conversation. The inputs can include a user's emotional well-being communicated via a mobile phone, other personal device and/or communication component. At 706, the emotional state is evaluated or ascertained based on the set of inputs. For example, the emotional state could be that the user is tired and wants a low keyed movie to fall asleep to after hours of travel, but does not want a romance. The system could evaluate these inputs as the user being bored, tired, etc. from the inputs and determine the surrounding facts from key terms such as traveling, low-key, and the like.

At 706, a set of media content is determined based on the emotional state. A set of media content can be tagged with ratings based on emotions elicited by the media content and the tags could be associated with different segments of the media content and/or for the media content overall. The tags are analyzed and based on the desired emotional response of the inputs determined from the emotional state of the user, a set of media content can be selected as options for recommendations. The media content can be based on ratings from other users and/or from metadata associated with the media content.

At 708, the set of recommendations associated with the set of media content are communicated to the user. The recommendations can be determined from the media content determined from the previous act 706 and extracted based on a predetermined threshold, such as by a ranking based on user likes or dislikes, and/or by the strength in which each emotion that is similar to the emotional state of the user was rated for the media content, for example. The media content can have multiple emotions as identified within the movie itself and/or as identified by other users or the current user as emotions elicited by the media content, for example.

In another example, communicating the recommendations can comprise communicating selections associated with each media content. For example, where the media content comprises movies or digital novels, for example, the recommendations can be in the form of selections. In response to receiving a selection, the media content itself can be communicated to the user for enjoyment. The user can then sample the media content, share the media content, etc. and further communicate a rating in return for an exchange, for example, such as a discount at the next media content recommendation purchase or rental.

In one embodiment, the set of measures can include emoticons or images of emotions that are expressed within the content that can be dynamically generated. The set of measures can include various emoticons displaying emotions or images that represent emotions caused by the media content. One or more users are prompted to select at least one measure to rate media content according to the emotion that the media content caused or is causing. For example, a sad face could be selected from the set of measures to indicate that the user feels sad after watching the particular movie, reading a particular book, etc. The inputs received by the users are analyzed and the media content is rated according to at least one measure selected. A movie, for example, is associated with a sad face thereafter. However, if no one expresses sadness then no sad faces would necessarily be associated with the movie. In other embodiments, all of the measures of the set of measures are associated with a movie and then rated according to various strength scores or indicators.

A set of weight indicators can also be generated that indicate weight factors that respectively correspond with the set of measures. Each weight indicator could provide the strength of the particular measure associated with the media content. For example, a happy face may have a 75% rating associated with the happy face emoticon and the movie or content media. Other emoticons could be generated as the set of measures or other images indicating emotions. For example, a romantic desire could be indicated by a heart or valentine day symbol. Various weight indicators are envisioned as discussed above, such as with percentages, bars, graphs, charts, strength indicators or fill emoticons where half the measure generated or a portion corresponding to the number of users expressing a particular emotions indicated by the emoticon could be generated.

In another embodiment, the system can receive a text based message having an emoticon to analyze as a representative of an emotion elicited by the media content. The emotion can then be recognized and associated with the media content for rating and further recommendation to be made to the user. A user profile can then be generated based on how well the elicited emotion from the user matches the original or initial assessment of the user's emotional state and the recommended content for the desired emotional response. For example, we know that when the user is sad, he selects cartoons often, and expresses happiness in the selection. The system could then make further recommendations based on a future assessment of sadness based on the past behavior, or make different categorical (genre, audience category, standard rating—G, PG, etc., time period of production or of writing, etc.) recommendations known to elicit an emotion by ranking those emotionally rated media content with a higher rating based on the past behaviors.

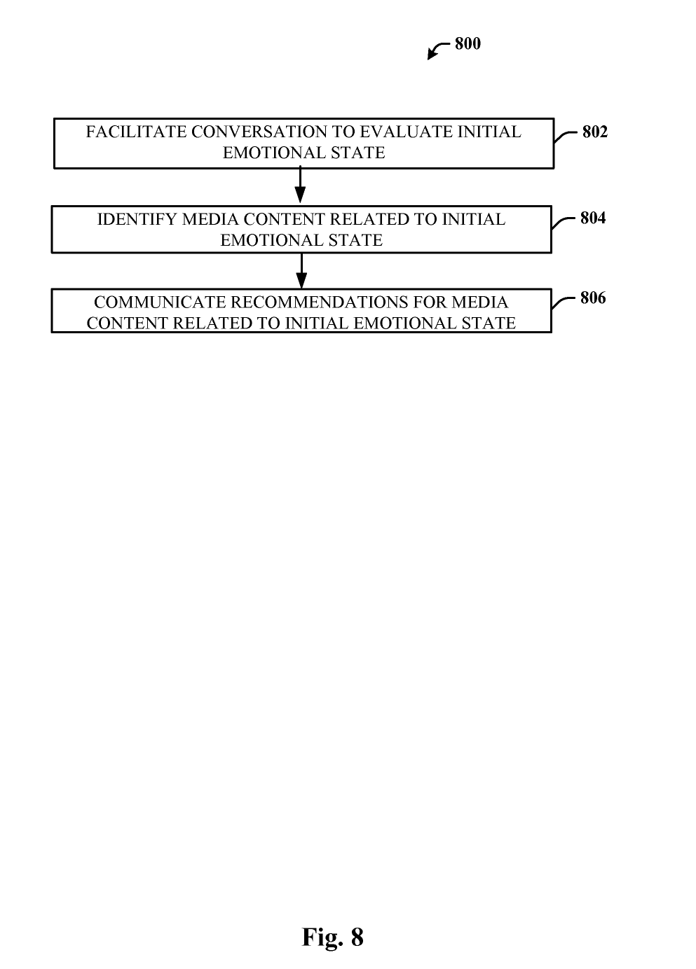

An example methodology 800 for implementing a method for a system such as a recommendation system for media content is illustrated in FIG. 8. Reference may be made to the figures described above for ease of description. However, the method 800 is not limited to any particular embodiment or example provided within this disclosure.

The method 800, for example, provides for a system to evaluate user emotions, recommend various media content and rate media content. At 802, the method 800 initiates with facilitating, by a system including at least one processor, a conversation to evaluate an initial emotional state for determining media content.

At 804, the media content related to the initial emotional state is identified. For example, media content can be stored in a data store, a network with resources (e.g., a cloud network), a server, and/or other data store, for example. At 806, recommendations for the media content that are related to the initial emotional state are communicated.

In one embodiment, a set of measures can be generated that correspond to emotions that rate the media content according to the emotions. For example, a client device can be prompted to provide at least one input based on a subsequent emotional state, which is elicited by the media content. A user profile can thus be learned by comparing the initial emotional state with the subsequent emotional state to further refine recommendations based on the difference. In cases where the user indicates wanting a sad movie, but is happier than expected, the system can alter the recommendations to provide movies ranked as more sad according to emotional measures (e.g., emoticons) provided as the subsequent emotions elicited after the media content is reviewed by the user. While sad and happy are generic any emotion can be applied and is envisioned herein.

In another embodiment, the user can input and the system implementing the method receive inputs that can include a user interface selection on a network (e.g., of an emotion depicted), a captured image, a voice command, a video, a freeform image and/or a handwritten image, wherein the at least one input conveys the subsequent emotional state elicited by the media content. An emoticon is another example, in which the input can be a text based image or emoticon that provides indication of the emotion elicited as a measure to the media content. The media content can then be ranked or rated according to the emotional responses received. For example, the media content can be tagged based on the subsequent emotional state determined from the inputs after reviewing the media content by the user.

### Exemplary Networked and Distributed Environments

One of ordinary skill in the art can appreciate that the various non-limiting embodiments of the shared systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

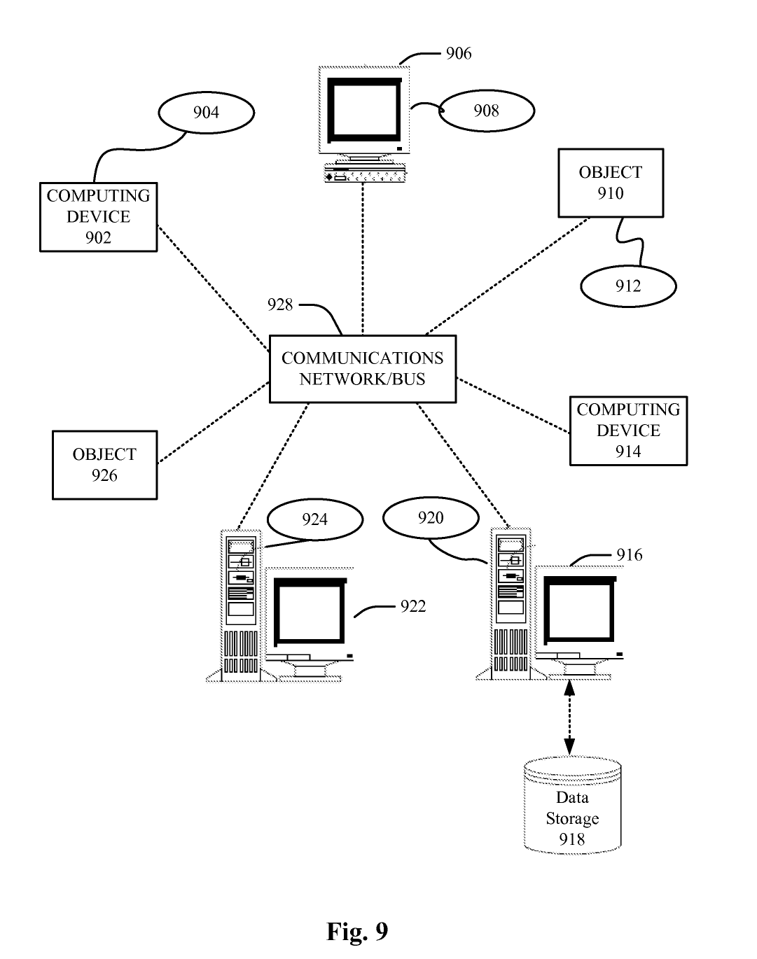

FIG. 9 provides a schematic diagram of an exemplary networked or distributed computing environment. The distributed computing environment comprises computing objects 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects 910, 912, etc. and computing objects or devices 920, 922, 924, 926, 928, etc. may comprise different devices, such as personal digital assistants (PDAs), audio/video devices, mobile phones, MP3 players, personal computers, laptops, etc.

Each computing object 910, 912, etc. and computing objects or devices 920, 922, 924, 926, 928, etc. can communicate with one or more other computing objects 910, 912, etc. and computing objects or devices 920, 922, 924, 926, 928, etc. by way of the communications network 940, either directly or indirectly. Even though illustrated as a single element in FIG. 9, communications network 940 may comprise other computing objects and computing devices that provide services to the system of FIG. 9, and/or may represent multiple interconnected networks, which are not shown. Each computing object 910, 912, etc. or computing object or device 920, 922, 924, 926, 928, etc. can also contain an application, such as applications 930, 932, 934, 936, 938, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects 910, 912, etc. can be thought of as servers where computing objects 910, 912, etc., acting as servers provide data services, such as receiving data from client computing objects or devices 920, 922, 924, 926, 928, etc., storing of data, processing of data, transmitting data to client computing objects or devices 920, 922, 924, 926, 928, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 940 or bus is the Internet, for example, the computing objects 910, 912, etc. can be Web servers with which other computing objects or devices 920, 922, 924, 926, 928, etc. communicate via any of a number of known protocols, such as the hypertext transfer protocol (HTTP). Computing objects 910, 912, etc. acting as servers may also serve as clients, e.g., computing objects or devices 920, 922, 924, 926, 928, etc., as may be characteristic of a distributed computing environment.

### Exemplary Computing Device

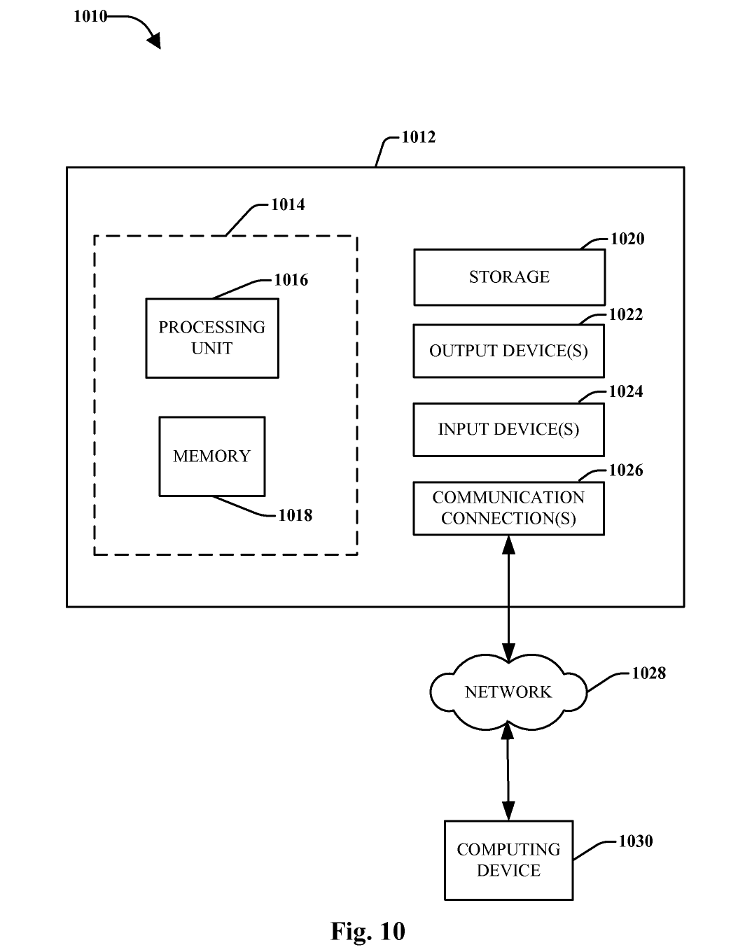

As mentioned, advantageously, the techniques described herein can be applied to a number of various devices for employing the techniques and methods described herein. It is to be understood, therefore, that handheld, portable and other computing devices and computing objects of all kinds are contemplated for use in connection with the various non-limiting embodiments, i.e., anywhere that a device may wish to engage on behalf of a user or set of users. Accordingly, the below general purpose remote computer described below in FIG. 10 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 10 and the following discussion provide a brief, general description of a suitable computing environment to implement embodiments of one or more of the provisions set forth herein. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” as used herein includes computer readable storage media and communication media. Computer readable storage media includes volatile and nonvolatile, removable and non-removable media implemented in any method or technology for storage of information such as computer readable instructions or other data. Memory 1018 and storage 1020 are examples of computer readable storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1010. Any such computer readable storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may also include communication media. Communication media typically embodies computer readable instructions or other data that may be communicated in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

1. A system, comprising:
a memory that stores computer-executable components;
a processor, communicatively coupled to the memory, that facilitates execution of the computer-executable components, the computer-executable components comprising:
a conversation component configured to facilitate a conversation and receive a set of inputs to evaluate an emotional state based on the set of inputs;
a recommendation component configured to generate a determination of a set of media content based on the emotional state and communicate a set of selections as recommendations associated with of the set of media content based on the determination; and
a media component configured to communicate the set of media content based on a selection of the set of selections being received.

2. The system of claim 1, the computer-executable components further comprising:
a voice component configured to communicate an audio content to facilitate the conversation for receiving the set of inputs.

3. The system of claim 1, wherein the conversation includes communicating a question comprising an open ended question or a set of multiple choice options related to the emotional state.

4. The system of claim 1, wherein the set of media content comprises a set of video content for viewing on a client device.

5. The system of claim 1, the computer-executable components further comprising:
a measuring component configured to generate a set of measures corresponding to the set of media content, wherein the conversation facilitated by the conversation component includes communicating a question comprising an open ended question or a set of multiple choice options related to an emotion caused by the set of media content.

6. The system of claim 5, wherein the conversation component is further configured to receive the set of inputs to further associate a measure with the set of media content, the set of measures including at least one of a set of pictorially represented emoticons, a multiple choice of emotions, or a text indication of the emotion for measuring the set of media content.

7. The system of claim 6, wherein the set of inputs received include a user interface selection, a text, a captured image, a voice command, a video, or a freeform image, that evaluates the set of media content according to the emotion caused by the set of media content.

8. The system of claim 5, the computer-executable components further comprising:
a rating component configured to detect the emotional state from the set of inputs and rate the set of media content according to a measure selected from the set of measures in response to the emotional state detected.

9. The system of claim 8, the computer-executable components further comprising:
a tagging component configured to analyze the set of media content and associate a tag to a set of segments of the set of media content based on the rating.

10. The system of claim 9, wherein the recommendation component is further configured to determine the set of media content based on the emotional state and the tag to the set of segments of the set of media content.

11. The system of claim 10, wherein the conversation component is further configured to communicate the set of measures to a mobile device to associate the emotion with the set of media content based on a measure received as part of the set of inputs.

12. The system of claim 10, the computer-executable components further comprising:
a profile component configured to generate user profile data with respect to time from the emotional state and the measure received of the set of measures.

13. The system of claim 12, wherein the recommendation component is further configured to generate the determination based on the tag of the set of media content, the measure received, and the emotional state determined.

14. The system of claim 13, wherein the tag identifies the set of media content with the emotional state.

15. The system of claim 11, the computer-executable components further comprising:
a classification component configured to classify the set of media content in a classification based on the set of measures, wherein the classification includes the emotion.

16. The system of claim 1, wherein the emotional state includes an emotion and circumstances surrounding the emotion comprising time of day, a date, an event or a location of a client device from which the set of inputs are received.

17. The system of claim 1, further comprising:
a display component configured to display the set of selections, the set of media content and the emotional state determined.

18. A method, comprising:
facilitating, by a system including at least one processor, a conversation to evaluate an emotional state;
receiving a set of inputs from the conversation;
evaluating the emotional state based on the set of inputs;
determining a set of media content based on the emotional state; and
communicating a set of recommendations associated with the set of media content.

19. The method of claim 18, further comprising:
communicating the set of media content based on a recommendation selection received from the set of recommendations.

20. The method of claim 18, wherein the evaluating the emotional state comprises determining an emotion to associate with the set of media content.

21. The method of claim 18, further comprising:
associating a tag to one or more portions of the set of media content based on an emotion indicated by a rating from one or more user devices.

22. The method of claim 21, further comprising:
identifying the set of media content based on the emotion associated with the set of media content from the tag.

23. The method of claim 18, further comprising:
communicating the set of media content based on a recommendation selection received from the set of recommendations; and
generating a set of measures corresponding to the recommendation selection for evaluating the set of media content based on an emotion from the set of media content.

24. The method of claim 23, further comprising:
prompting a user device to select at least one measure from the set of measures to rate the set of media content based on the emotion, wherein the set of measures include an emoticon or graphical symbol of the emotion.

25. The method of claim 24, further comprising:
rating the set of media content based on the at least one measure selected from the set of measures.

26. The method of claim 18, further comprising:
generating a set of user profile data with respect to time from the emotional state and a rating associated with the set of media content.

27. The method of claim 26, wherein the communicating the set of recommendations comprises:
determining the set of recommendations based on the emotional state determined and the set of user profile data.

28. The method of claim 27, further comprising:
displaying the set of recommendations for selection of the set of media content by a user device.

29. The method of claim 18, wherein the facilitating the conversation includes communicating a question related to the emotional state.

30. A computer readable storage medium configured to store computer executable instructions that, in response to execution, cause a computing system including at least one processor to perform operations, comprising:
facilitating, by a system including at least one processor, a conversation to evaluate an initial emotional state for determining media content;
identifying the media content related to the initial emotional state; and
communicating recommendations for the media content related to the initial emotional state.

31. The computer readable storage medium of claim 30, the operations further comprising:
generating a set of measures corresponding to emotions that rate the media content; and
prompting a client device to provide at least one input based on a subsequent emotional state elicited by the media content.

32. The computer readable storage medium of claim 31, the operations further including:
receiving the at least one input, the at least one input including at least one of a user interface selection on a network, a captured image, a voice command, a video, a freeform image or a handwritten image, wherein the at least one input conveys the subsequent emotional state elicited by the media content.

33. The computer readable storage medium of claim 32, the operations further including:
analyzing the at least one input received to determine the subsequent emotional state.

34. The computer readable storage medium of claim 31, wherein the generating the set of measures includes generating images that represent the emotions.

35. The computer readable storage medium of claim 33, the operations further including:
tagging the media content based on the subsequent emotional state determined from the at least one input; and
determining the recommendations of the media content based on the initial emotional state determined and a subsequent emotional response from a previous media content.

36. The computer readable storage medium of claim 35, wherein the tagging the media content comprises associated one or more ratings of the media content based on the subsequent emotional response from a plurality of user devices.
